(19) United States
(12) Patent Application Publication
(10) Pub. No.: US 2011/0047691 A1
(43) Pub. Date: Mar. 3, 2011

(54) Multifunctional SPA Device

(76) Inventors: Cheng-Hsiang Huang, Toufen Township (TW); Kuang-Chao Huang, Toufen Township (TW)

(21) Appl. No.: 12/551,629

(22) Filed: Sep. 1, 2009

(51) Int. Cl. A61H 33/04

(52) U.S. Cl. 4/541.6

(57) ABSTRACT

A multifunctional SPA device comprises: a pump, a vent pipe connected to an inlet end of the pump, and a jet connected to an outlet end of the pump, so that air will be sucked by the vent pipe and mixed with water in the pump when the pump sucks water via an intake pipe, allowing the jet to pump out water column containing rich micro bubbles.

### BACKGROUND OF THE INVENTION

1. Field of the Invention The present invention relates to a multifunctional SPA device, which is provided with a vent pipe connected to an inlet end of the pump, so that air will be sucked by the vent pipe and mixed with water in the pump when the pump sucks water via an intake pipe, allowing the jet to pump out water column full of micro bubbles.

2. Description of the Prior Art

SPA is abbreviated for “Solus Por Aqua”, which means health by water, however, a SPA device is usually expensive and has a large size since it comprises massage bathtub, different-pressure jets, anion generator, and etc. Furthermore, all the parts of the SPA device must be installed as a whole in advance and cannot be directly installed on an already-formed bathtub, that's why the SPA can only be used for commercial purposes.

The power of a conventional SPA massage bathtub is supplied from a pump which produces a massage function by sucking the water of the bathtub in and pumping it out, repeatedly. Some of the water will reside in the pump, therefore, when anyone uses the SPA, it cannot make sure that the water in the bathtub is completely clean because the water residue in the pump will be pushed into the bathtub again through the massage jets, causing the problem that the waste water cannot be completely pumped out (some of the water residues in the pipe between the inlet of the bathtub, the inlet of the pump and the pump.

In addition, every massage bathtub, every different-pressure jet and anion generator and etc must be installed with different function structures; therefore, it requires a relatively large installation space and high cost that not every family can afford it.

The present invention has arisen to mitigate and/or obviate the afore-described disadvantages.

### SUMMARY OF THE INVENTION

The primary object of the present invention is to provide a multifunctional SPA device which comprises: a pump, a vent pipe connected to an inlet end of the pump, and a jet connected to an outlet end of the pump, so that air will be sucked by the vent pipe and mixed with water in the pump when the pump sucks water via an intake pipe, allowing the jet to pump out water column full of micro bubbles.

Since the outlet end of the pump is provided with a jet, when the intake pipe of the pump sucks water from the bathtub, the water coming out of the jet at the initial time will be squirted out of the bathtub, so that the waste water residue in the pump and the pipes thereof can be expelled out completely, ensuring that the water of the bathtub is clean. When the jet is put into the bathtub, the pump sucks in air via the vent pipe (when the water is continuously pumped out of the intake pipe by the pump, it will produce a vacuum sucking force to suck the air from the vent pipe), it can keep producing bubble water column to massage the user.

Furthermore, since the air intake of the vent pipe is controlled by the valve, the pressure of the pump will be adjustable (air is compressible, the bigger the air intake, the smaller the outputted water pressure), so that the jet can pump out water at different pressures and can be hold by the user to spray at the user's body directly. Or, putting the jet into the bathtub can allow the water of the bathtub to instantly produce countless micro bubbles and become milk white, increasing the O3 concentration of the water and producing anion effect. The micro bubbles can reach deep into pores to do deep cleansing, further, the micro bubbles with rich oxygen can increase the oxygen content of the user's skin, helping remove toxins and enhance blood circulation).

### BRIEF DESCRIPTION OF THE DRAWINGS

FIG. 1 is an assembly view of a multifunctional SPA device in accordance with the present invention;

FIG. 2 shows the interior structure of the multifunctional SPA device in accordance with the present invention;

FIG. 3 is an illustrative view showing that the multifunctional SPA device in accordance with the present invention is installed on a bathtub;

FIG. 4 is a flow chart illustrating the steps of operating the multifunctional SPA device in accordance with the present invention;

FIG. 5 is an exploded view of a jet of the multifunctional SPA device in accordance with the present invention;

FIG. 6 is an illustrative view showing that the jet is put into the bathtub; and

FIG. 7 is an illustrative view showing that the jet is hold by a user.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

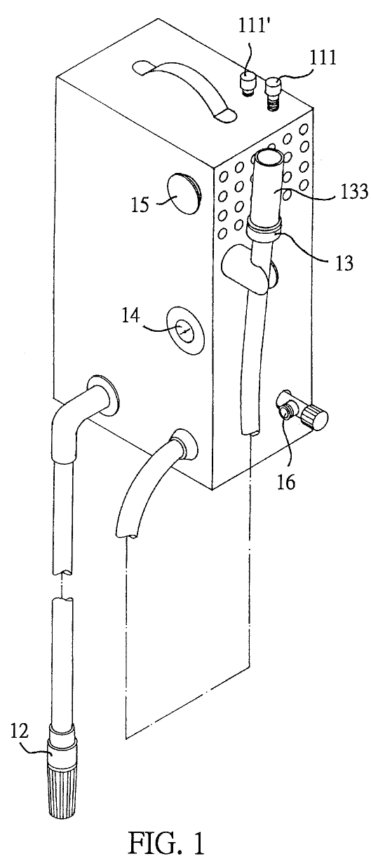

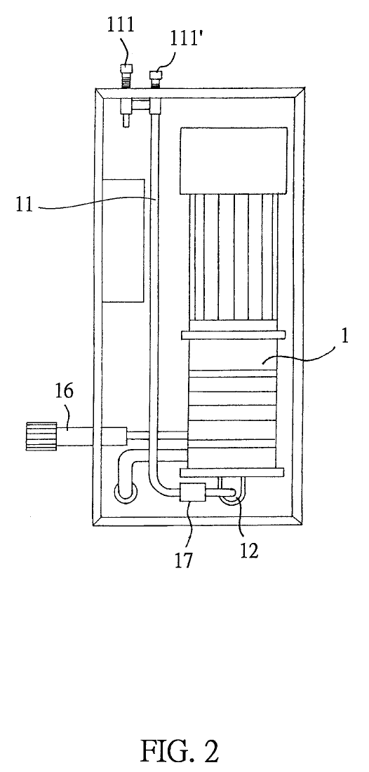

Referring to FIGS. 1 and 2, a multifunctional SPA device in accordance with the present invention comprises a pump 1, a vent pipe 11 connected to an inlet end of the pump 1, and a jet 13 connected to an outlet end of the pump 1. Between the pump 11 and the invent pipe 11 is arranged a normally closed solenoid valve 17 which is controlled by a switch 15, so that air will be sucked by the vent pipe 11 and mixed with water in the pump 1 when the pump 1 sucks water via an intake pipe 12, allowing the jet 13 to pump out water column full of micro bubbles.

The vent pipe 11 is provided with the valve 111 to adjust the air intake, the bigger the air intake, the less water sucked in the pump 1 (and air is compressible), therefore, and the pressure of the water pumped out from the pump 1 will be reduced. And the reverse is also true, when the valve 111 is closed; the pressure of the water pumped out from the pump 1 will increase, and thus the pressure of the water pumped out from the pump 1 can be adjusted by adjusting the valve 111.

Furthermore, there is another valve 111′ connected in series to the valve 111 in such a manner that the valve 111′ is adjusted and fixed at a position where the air flow and the pressure change of the pump 1 can produce optimum mixing effect. The valve 111 can be adjusted by the user. Hence, when the valve 111 is fully opened (to its max position), the other valve 111′ can totally control the mixing ratio of water and air so as to produce an effect of bubble fountain. When the valve 111 is turned down to reduce the air flow of the vent pipe 11, the pressure of the pump 1 will be increased (the present invention is provided with a pressure gauge 14 to check the pressure of the pump 11), making the jet 13 push out water column with different pressures.

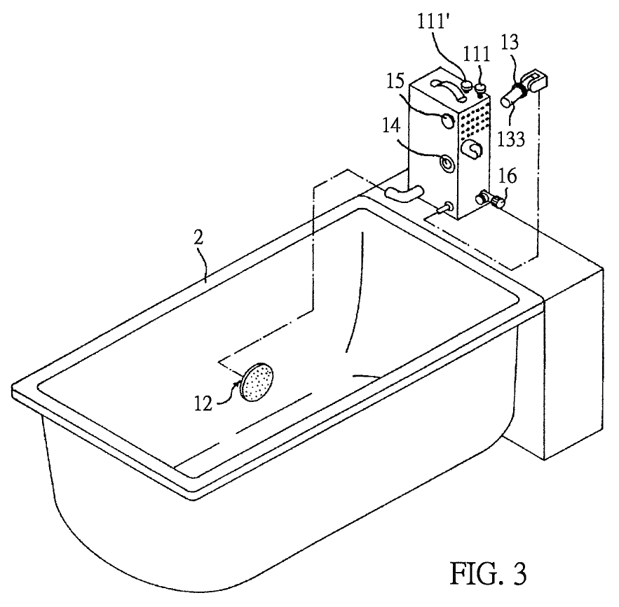

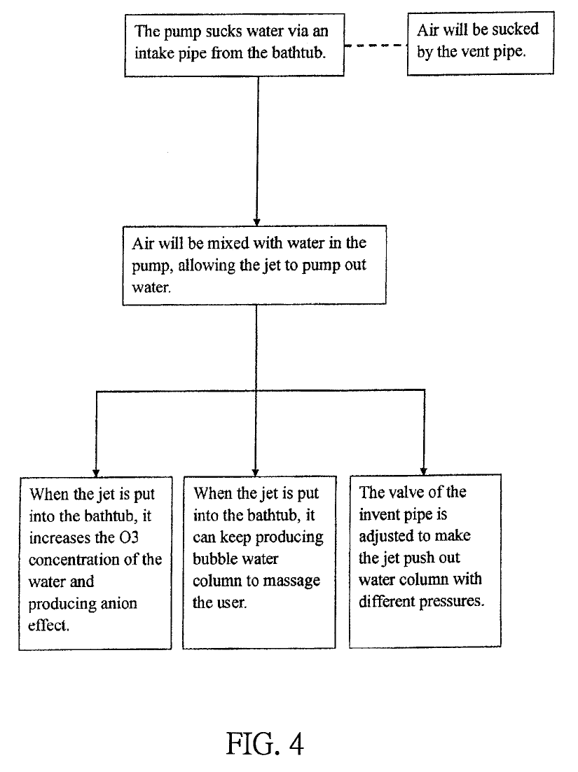

When the user switches on the switch 15 to make the intake pipe 12 suck water from the bathtub 2, (as shown in FIG. 3, the intake pipe 12 is provided with a check valve, and the normally closed solenoid valve 17 can stop air from being sucked into the vent pipe 11 before the pump 1 is turned on, so as to prevent water from flowing out of the pump 1 and forming vacuum. When all the water in the pump 1 completely flows out by accident, water can be refilled into the pump 1 via a water feed valve 16, and the intake pipe 12 can be also be fixed in the bathtub 2 in a stationary manner) the water coming out of the jet 13 at the initial time will be squirted out of the bathtub 2, so that the waste water residue in the pump 1 and the pipes thereof can be expelled out completely. When the jet 13 is put into the bathtub 2, it can keep producing bubble water column to massage the user. Furthermore, the valve 111′ can allow the water of the bathtub 2 to instantly produce countless micro bubbles and become milk white, increasing the O3 concentration of the water and producing anion effect. The jet 13 can also be used to spray the user with water of different pressures, as shown in FIG. 4.

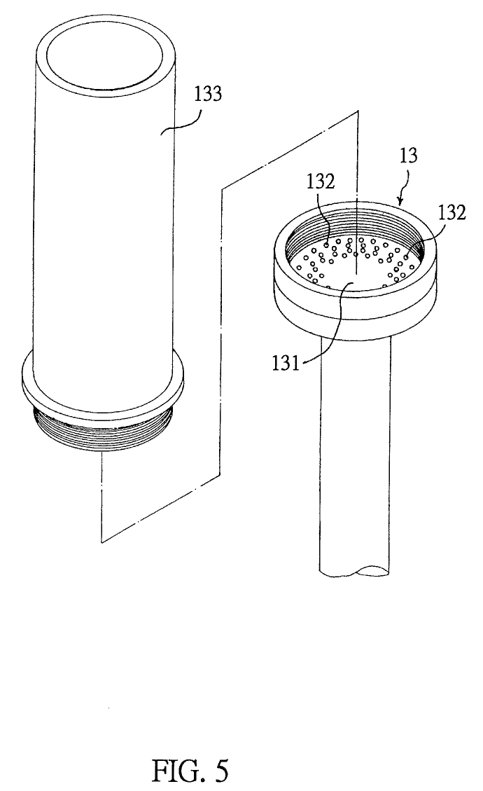

In addition, the jet 13 is interiorly provided with a thin spray disc 131 (as shown in FIG. 5) which is defined with a plurality of small orifices 132 annularly arranged in the outer periphery thereof, so as to produce thin water fog.

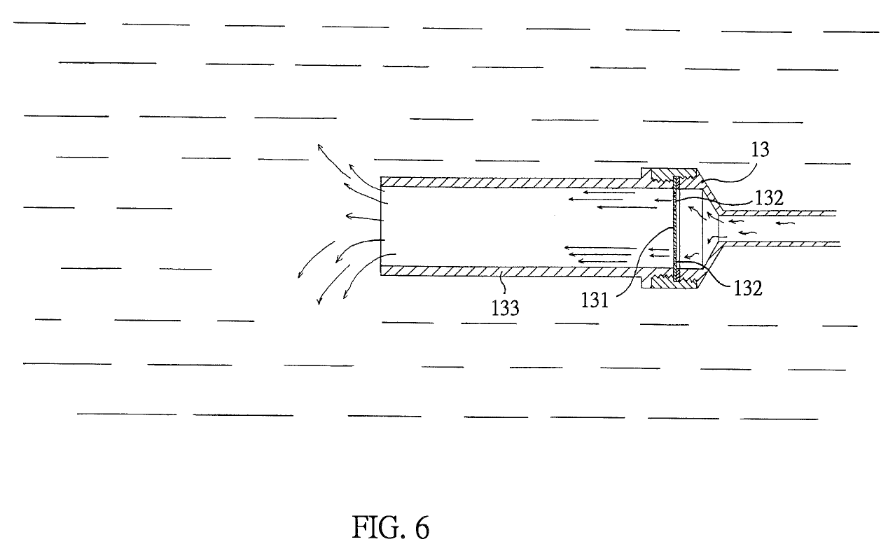

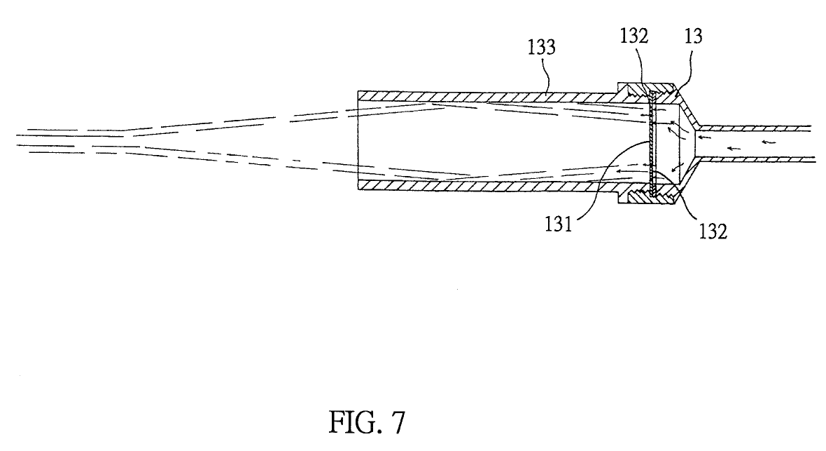

The jet 13 can further be connected with a pipe 133, when the jet 13 sprays out water via the pipe 133, since all the orifices 132 are arranged at the outer periphery of the spray disc 131, the water sprayed out of the spray disc 131 will be bounced off the inner surface of the pipe 133, forming turbulence in the bathtub 2, as shown in FIG. 6, and making the bubbles finer (when the jet 13 is hold by the user, the water flow sprayed out of the pipe 133 is a water column, as shown in FIG. 7.

While we have shown and described various embodiments in accordance with the present invention, it is clear to those skilled in the art that further embodiments may be made without departing from the scope of the present invention.

What is claimed is:

1. A multifunctional SPA device comprising: a pump, a vent pipe connected to an inlet end of the pump, and a jet connected to an outlet end of the pump, so that air will be sucked by the vent pipe and mixed with water in the pump when the pump sucks water via an intake pipe, allowing the jet to pump out water column with rich micro bubbles.

2. The multifunctional SPA device as claimed in claim 1, wherein the vent pipe is provided with a valve to adjust an air intake, so as to adjust output pressure of the jet of the pump.

3. The multifunctional SPA device as claimed in claim 1, wherein the vent pipe is provided with two series-connected valves, one of valves is adjusted and fixed at a position where air flow and pressure change of the pump can produce optimum mixing effect, and the other of valves is adjusted by a user.

4. The multifunctional SPA device as claimed in claim 1, wherein the jet is interiorly provided with a thin spray disc which is defined with a plurality of small orifices annularly arranged in an outer periphery thereof, so as to produce thin water fog.

5. The multifunctional SPA device as claimed in claim 1, wherein the jet is connected with a pipe, when the jet sprays out water via the pipe, a turbulence effect is formed inside the pipe.

6. The multifunctional SPA device as claimed in claim 1, wherein a normally closed solenoid valve which is controlled by a switch is disposed between the pump and the invent pipe.
